(19) United States
(12) Patent Application Publication
(10) Pub. No.: US 2025/0326326 A1
(43) Pub. Date: Oct. 23, 2025

(54) Method for operating a vehicle with an electronic steering system and electronic steering system

(71) Applicant: Ford Global Technologies, LLC, Dearborn, MI (US)

(72) Inventors: Alexander Ein Waldt, Köln (DE); Goetz-Philipp Wegner, Dortmund (DE); Oliver Nehls, Düsseldorf (DE); Sergio Codonesu, Aachen (DE); Gerhard Friederich, Bornheim (DE)

(21) Appl. No.: 19/179,826

(22) Filed: Apr. 15, 2025

(30) Foreign Application Priority Data
Apr. 17, 2024 (DE) 102024110818.5

(51) Int. Cl. B60L 58/12; B62D 5/04

(52) U.S. Cl. CPC B60L 58/12; B62D 5/0484

(57) ABSTRACT

The disclosure generally relates to a method for operating a vehicle with an electronic steering system and to an electronic steering system. A method for operating a vehicle with an electronic steering system includes detecting a fault in at least one of a first steering system component or a second steering system component, determining a first range of a vehicle based on the fault in the at least one of the first steering system component or the second steering system component, determining adjusted range information of the vehicle based on a comparison of the first range with a battery range of the vehicle, and substituting the battery range of the vehicle in an output device of the vehicle with the adjusted range information.

### RELATED APPLICATION

This patent claims priority from DE Patent Application Number 102024110818.5, which was filed on Apr. 17, 2024, and is hereby incorporated herein by reference in its entirety.

### FIELD OF THE DISCLOSURE

The disclosure generally relates to a method for operating a vehicle with an electronic steering system and to an electronic steering system.

### BACKGROUND

Electronic steering systems are an emerging steering technology that eliminate the mechanical link between the steering wheel and the road wheel and replaces it with two actuators: an actuator which generates a torque to provide feedback for the driver (on the steering wheel), and a wheel actuator that controls the road wheels into the desired position.

### SUMMARY

A method includes detecting a fault in at least one of a first steering system component or a second steering system component, determining a first range of a vehicle based on the fault in the at least one of the first steering system component or the second steering system component, determining adjusted range information of the vehicle based on a comparison of the first range with a battery range of the vehicle, and substituting the battery range of the vehicle in an output device of the vehicle with the adjusted range information.

An electronic steering system for a vehicle includes a first steering system component, a second steering system component, and a control device including machine-readable instructions to cause the control device to detect a fault in either of the first and second steering system components, determine a first range of the vehicle for which the vehicle can continue to be operated with a non-faulty one of the first and second steering system components, set an adjusted range information equal to the first range based on the first range being less than a battery range of the vehicle, set an adjusted range information equal to the battery range based on the first range being greater than the battery range, and substitute the battery range in an output device of the vehicle with the adjusted range information.

A steering system for a vehicle includes a first sensor, a second sensor, and a control device with machine-readable instructions to cause the control device to detect a fault in either of the first sensor or the second sensor,
determine a first range of the vehicle for which the vehicle can continue to be operated with a non-faulty one of the first sensor or the second sensor, determine adjusted range information based on a comparison of the first range and a battery range of the vehicle, and substitute the battery range of the vehicle in a display of the vehicle with the adjusted range information.

### BRIEF DESCRIPTION OF THE DRAWINGS

FIG. 1 shows a vehicle with an example electronic steering system.

FIG. 2 is a flowchart representative of example machine-readable instructions and/or example operations that may be executed, instantiated, and/or performed by example programmable circuitry to implement electronic steering systems of vehicles in accordance with examples disclosed herein.

FIG. 3 is a graph of range information of a vehicle that may be used to implement examples disclosed herein.

FIG. 4 is another graph of adjusted range information that may be used to implement examples disclosed herein.

FIG. 5 is a block diagram of an example processing platform including programmable circuitry structured to execute, instantiate, and/or perform the example machine readable instructions and/or perform the example operations of FIG. 2.

In general, the same reference numbers will be used throughout the drawing(s) and accompanying written description to refer to the same or like parts. The figures are not necessarily to scale.

### DETAILED DESCRIPTION

Since a system fault could lead to loss of steering function, redundant systems are used. However, after a first fault of a first component, a fault of the second component that is intended to provide redundancy could lead to a complete loss of steering function. To ensure reliability of the steering system, according to previous approaches, continued operation of the remaining system after the fault of the first component is limited. In this context, it is known to reduce the vehicle speed (see e.g. U.S. Pat. No. 11,780,493 B2, U.S. Pat. No. 11,192,581 B2, US 2023/0406405 A1 and EP 1 650 104 A1) or to provide a range limitation (see e.g. DE 10 2022 002 249 A1).

However, the forced speed reduction of a vehicle is typically surprising for the driver. Many drivers are reluctant to accept the forced speed reduction, which can lead to unwanted driving situations. In addition, stopping the vehicle at a current vehicle position may be inappropriate in, for example, tunnels.

Examples disclosed herein overcome the disadvantages of prior methods and electronic steering systems. For example, examples disclosed herein provide methods and electronic steering systems that increase a driver's acceptance of measures taken as a result of a component fault compared to previous approaches.

Some examples of the disclosure relate to methods of operating a vehicle with an electronic steering system. The electronic steering system includes at least a first steering system component and a second steering system component. The second steering system component is redundant relative to the first steering system component. The methods include at least the following:

A fault in either of at least the first steering component or the second steering system components is detected.

A steering system remaining range of the vehicle is determined for which the vehicle can continue to be operated with the other of the first steering system component or the second steering system component.

The range information is adjusted based on the steering system remaining range.

Adjusted range information is output via a notification to the driver of the vehicle.

Disclosed example methods are based on the idea of not compelling the driver of the vehicle to reduce speed, but rather of providing the driver with adjusted range information. Drivers are familiar with the fact that the range of the vehicle is limited. Example methods disclosed herein exploit this insight by adjusting the range information issued to the driver based on the steering system remaining range. This leads to a higher acceptance by the driver of the adjusted functionality of the vehicle to substantially reduce or eliminate unwanted driving situations and to increase the likelihood that the driver follows the changed information. This is generally not the case for example, a simple error message indicating that the electronic steering system has a fault.

In addition, example methods disclosed herein make use of the fact that the steering system remaining range is not simply pre-defined and, thus, fixed. Rather, in examples disclosed herein, the steering system remaining range is determined during the course of the disclosed methods. This means that the circumstances of the driving situation can be taken into account, so that possible limitations on the driver being able to continue to operate the vehicle are reduced.

Some examples of the disclosure also relate to an electronic steering system for a vehicle. The electronic steering system includes a first steering system component, a second steering system component and a control device which is coupled at least to the first steering system component, the second steering system component, and to an output device. The second steering system component is redundant relative to the first steering system component. The electronic steering system is designed to detect a fault in either of the first and the second steering system components, to determine a steering system remaining range of the vehicle for which the vehicle can continue to be operated with the other of the first and second steering system components, to adjust the range information based on the steering system remaining range, and to output adjusted range information via a notification to the driver of the vehicle using the output device.

The advantages achieved by the methods described herein are also achieved by the electronic steering system in a corresponding manner.

The electronic steering system can be understood to be a steer-by-wire (SbW) steering system.

The steering system remaining range is understood to mean a range of the vehicle during which the vehicle may still be reliably used with the electronic steering system using the second steering system component. This range is limited in the present case to minimize the probability of a fault in the second steering system component provided for redundancy purposes and, thus, in the entire electronic steering system.

In some examples, the steering system remaining range depends at least indirectly on a permissible operating time of the vehicle after the fault in one of the first and second steering system components.

The range information can be understood as a specified remaining range of the vehicle. Alternatively, it can also mean a fill level of, for example, an energy storage device or fuel tank of the vehicle. In any case, the vehicle driver is informed by way of the range information that the vehicle can only be used for a limited time and/or a limited distance.

For the sake of brevity, it is assumed in the following that the fault with respect to the first steering system component is detected and that the steering system remaining range of the vehicle is determined with respect to the (fault-free) second steering system component. However, this is not a limitation. In general, the fault may of course occur and be detected on any of the mutually redundant steering system components. The steering system remaining range is then determined accordingly based on the other component.

In some examples, the electronic steering system may also have additional steering system components that are redundant relative to both, namely the first and the second steering system components. A fault may then occur and be detected with respect to any one of the mutually redundant steering system components. As a result, the steering system remaining range of the vehicle, for which the vehicle can continue to be operated with at least one other of the mutually redundant steering system components, can be determined. Then, the electronic steering system can adjust the range information based on the corresponding steering system remaining range such as, for example, the largest of them (or the smallest), and output the adjusted range information by way of a notification to the driver of the vehicle via the output device. In other words, the method and the electronic steering system can also be extended in a corresponding manner by a third (or fourth) steering system component, each of which is redundant relative to the first and second steering system components.

In some examples, the fault in the first steering system component can be detected via a sensor and/or the control device. For example, the sensor may detect that the steering system component is not operating properly. For example, if the steering system component is an actuator, the sensor can be used to determine that the actuator is not moving an actuating element as required. In such examples, the sensor can be a displacement sensor. If the steering system component itself is a sensor, a fault can be detected using, for example, the control device. For example, a measurement value actually expected from the sensor may be missing. For example, it can then be determined based on a voltage sensor that no measured value has been received at an input of the control device which is coupled to the sensor (e.g., a steering system component). This may indicate the fault in the steering system component. This provides a reliable detection mechanism for the fault of a steering system component.

A fault of a steering system component does not necessarily have to correspond to complete inoperability. The steering system component fault may also correspond to an unwanted mode of operation of the steering system component that is outside a predefined standard range. For example, sensors as steering system components may transmit measured values to the control device within a defined interval. However, if the measured value is transmitted outside the interval, a fault in the sensor (e.g. a steering system component) can be assumed. This means that steering system components that are still operable, but with incorrect or unreliable measured values, can be captured so that the functionality of the electronic steering system is maintained by the redundant additional steering system components. This allows the vehicle to continue to operate, at least with a lower performance of the electronic steering system.

In some examples, the first steering system component and the second steering system component may be arranged and coupled to each other in such a way that the second steering system component automatically assumes the functionality of the first steering system component if the first steering system component becomes unavailable or inoperable. This minimizes or substantially decreases the response time needed to switch over to the additional steering system component.

In other examples, the control device can also output a corresponding actuating signal to the second steering system component, so that the second steering system component assumes the functionality of the first steering system component. The actuating signal can be output if the control device has previously determined that a fault is present in the first steering system component based on, for example, the detection by means of a sensor. This enables adjusted actuating signals to be output to the components of the electronic steering system so that the response mechanisms optimized for the situation are triggered.

In some examples, the steering system remaining range of the vehicle is determined by the control device of the electronic steering system.

The notification can be output to the driver of the vehicle via, for example, an output device (e.g., a display, a loudspeaker, a wirelessly transmitted notification signal (e.g., to a tablet or smartphone, or a haptic output device such as, for example, a steering wheel that is made to vibrate). As a result, the availability of information regarding the state of the vehicle is increased for the driver, as the notification can be issued to the driver in a variety of ways.

In some examples, the first steering system component and the second steering system component are steering actuators. The steering actuators may be actuators with feedback to be able to provide the driver feedback about the steering movements on the steering wheel. In other examples, the steering actuators may be wheel actuators to output the steering angle specified by the driver for the steerable road wheels via the steering wheel to cause a steering movement of the vehicle. The method is, therefore, applicable to different devices of the electronic steering system.

In some examples, the first steering system component and the second steering system component may include other components of the electronic steering system, such as sensors. A fault in the sensors also impairs the functionality of the electronic steering system. Therefore, an adjusted driving functionality of the vehicle is also provided in the event of a sensor fault.

In any case, however, the first steering system component and the second steering system component are redundant relative to each other. This means that the steering system components implement the same functionality. Of course, the electronic steering system has multiple combinations of steering system components, which are each redundant relative to each other. Examples methods described herein can be applied equally to all groups of mutually redundant steering system components of the electronic steering system.

In some examples, the range information is adjusted at least also based on a battery remaining range of the vehicle. This increases the versatility of example methods disclosed herein, as several influencing factors are considered for the adjusted range information.

In some examples, the adjustment of the range information is based on a comparison of the steering system remaining range and the battery remaining range.

In other examples, the adjusted range information corresponds to the battery remaining range if the battery remaining range is less than the steering system remaining range, and the adjusted range information corresponds to the steering system remaining range if the steering system remaining range is less than the battery remaining range. In other words, the range information output to the driver can also correspond to the range information output before the fault in the first steering system component and can, thus, remain unchanged if the vehicle battery range is less than the steering system range. This increases efficiency of examples methods disclosed herein. In addition, the driver can be prevented from receiving contradictory range information. The range information is limited based on the steering system remaining range if the steering system remaining range is smaller than the battery remaining range. This substantially ensures that the vehicle will not continue to operate for too long, even though the first steering system component has become unavailable or inoperable. Unwanted driving situations can, thus, be prevented.

In some examples, the range information is not adjusted spontaneously, but continuously (e.g., dynamically). A sudden change in the range information could generally lead to reduced compliance by the driver of the vehicle. Therefore, the range information output to the driver of the vehicle via repeated notifications can be continuously varied over a predefined time interval from an initial value to a final value. The final value then corresponds to the range information such as, for example, the battery remaining range or the steering system remaining range, as described above. The final value can be set based on a distance travelled over the time interval, which is subtracted from the corresponding range information. The time interval is preferably dimensioned such that the distance corresponding to the adjusted range information cannot be covered during the time interval. In other words, the time interval may also correspond to a distance equal to a portion of the distance that corresponds to the adjusted range information.

In some examples, a charging process of a battery of the vehicle is limited in such a way that the total battery remaining range corresponds at most to the steering system remaining range. The total battery remaining range is the sum of the battery remaining range before and after the charging process. In the event that the battery remaining range is less than the steering system remaining range, the adjusted range information is determined by, for example, the battery remaining range. The driver can then drive to a charging station to charge the vehicle against the background of the low battery remaining range. This would lead to a significant increase in the battery remaining range. In this case, the charging process can be limited by, for example, a charging threshold value, in such a way that only a limited electrical charge is stored in the battery. As a result, after charging, the resulting available battery remaining range, together with the battery remaining range available before charging, can correspond to the steering system range. It is, thus, possible to prevent a charging process from increasing the adjusted range information output to the driver of the vehicle beyond a level that is not provided for according to the steering system remaining range, or in other words, a permissible level. This can substantially prevent or reduce the likelihood of the driver operating the vehicle for too long despite the unavailability or inoperability of a steering system component.

In some examples, the steering system remaining range is determined at least also based on position information. The position information includes a location of the vehicle and at least one of a charging station location, a parking space location, a garage location and a home location. Here it becomes clear that the steering system remaining range is not predefined. Instead, the size of the steering system remaining range may be set at a relative position of the vehicle with respect to one or more locations of charging stations, car parks or garages. For example, the range information can then be adjusted based on the steering system remaining range such that the remaining range of the vehicle indicated to the driver corresponds to the distance to a garage where the driver can have the steering system of the vehicle checked.

The position information can be received or obtained from, for example, a position receiver and/or a data connection to an external server. The position receiver may be configured to, for example, receive a signal from a global navigation satellite system and, thus, to be able to determine the position of the vehicle. For example, the data connection may exist between the control device and the external server. The data connection can be used to receive position information about charging stations, car parks or garages (e.g., service points) in the vicinity of the vehicle and to determine this information via the control device.

In some examples, the notification issued to the driver of the vehicle may also include information about the location of charging stations, car parks or workshops that can be reached based on the range information displayed to the driver.

As used herein, car parks are understood to mean a dedicated parking facility. For example, such a parking facility cannot be provided within a tunnel. In such examples, the steering system remaining range may correspond at least to a distance to be overcome to exit a tunnel, if the vehicle is inside the tunnel at the time of the fault of the steering system component.

In some examples, the range information can be adjusted such that it is not greater than a range threshold value which corresponds to a maximum distance for which the vehicle can still be operated with the electronic steering system. The maximum distance can depend on the maximum permissible duration of the vehicle for which the vehicle may still be operated after a fault of the first steering system component. This prevents the vehicle from being operated for an inadmissibly long time despite a failed steering system component to prevent unwanted driving situations.

In some examples, the steering system remaining range is determined at least also based on an actual driving profile of the driver of the vehicle and/or a standardized driving profile of a driver of the vehicle.

The actual driving profile can correspond to the driving profile that is used as the basis for the conventional range calculation of the vehicle. For example, the individual driving style of the driver can be considered regardless of, for example, whether the driver drives economically or energy-intensively. However, to determine the actual driving profile, the driving profile considered in the conventional range calculation can be multiplied by a factor (e.g., typically less than 1) which corresponds to the maximum permissible period of time for which the vehicle is to be operated with the electronic steering system after the fault of the first steering system component.

The standardized driving profile can be understood as, for example, an average driving profile that has been determined over an average of different drivers for the respective driving situation. Such a standardized driving profile can also be based on, for example, the environment in which the vehicle is currently moving (e.g., a fast road, a motorway or city traffic).

These measures make it possible to determine the steering system remaining range based on the driving situation, considering different types of information. The vehicle is, thus, allowed to continue to operate only for an adjusted range while substantially reducing or eliminating inconvenience to the driver of the vehicle in terms of the restricted continued operation.

In some examples, a vehicle speed is reduced after a range defined by the adjusted range information has been covered. This ensures an additional mechanism to substantially prevent or reduce unwanted driving situations and to encourage the driver to park the vehicle and/or have the electronic steering system checked.

In some examples, the vehicle can also be stopped after covering a range defined by the adjusted range information. This reliably prevents the vehicle from continuing to operate.

Examples disclosed herein further relate to a vehicle with an electronic steering system as explained above. The advantages achieved by the electronic steering system (and the methods) described herein are also achieved by the vehicle in a corresponding manner.

For the purposes of this disclosure, vehicles may include, for example, land vehicles, including, but not limited to, off-road and road vehicles such as passenger cars, buses, trucks and other utility vehicles. Vehicles may be manned or unmanned. Vehicles may be at least partially electrically driven, have an internal combustion engine and/or an electric motor serving as the drive.

All the features explained regarding the various aspects can be combined individually or in (sub)combination with other aspects.

The disclosure as well as other advantageous examples and refinements thereof are described and explained in more detail below with reference to the examples shown in the drawings.

The following detailed description in conjunction with the accompanying drawings, in which identical numbers refer to identical elements, is intended to describe different examples of the disclosed subject matter and is not intended to represent the only examples. Each example described in this disclosure is intended for illustration purposes only and should not be interpreted as preferred or advantageous over other examples. The illustrative examples contained herein do not claim to be complete and do not limit the claimed subject matter to the exact disclosed forms. Different variations of the described examples are readily discernible to those skilled in the art, and the general principles defined herein may be applied to other examples and applications without departing from the spirit and scope of the examples described. Therefore, the examples described are not limited to the examples shown but have the broadest possible scope compatible with the principles and features disclosed herein.

All the features disclosed below with respect to the described examples and/or the accompanying figures may be combined alone or in any sub combination with features of the aspects of the disclosure, provided that the resulting combination of features makes sense to a person skilled in the art in the relevant field.

For the purposes of the disclosure, the wording “at least one of A, B and C” means, for example, (A), (B), (C), (A and B), (A and C), (B and C) or (A, B and C), including any other possible combinations if more than three items are listed. In other words, the term “at least one of A and B” in general means “A and/or B”, namely “A” alone, “B” alone or “A and B”.

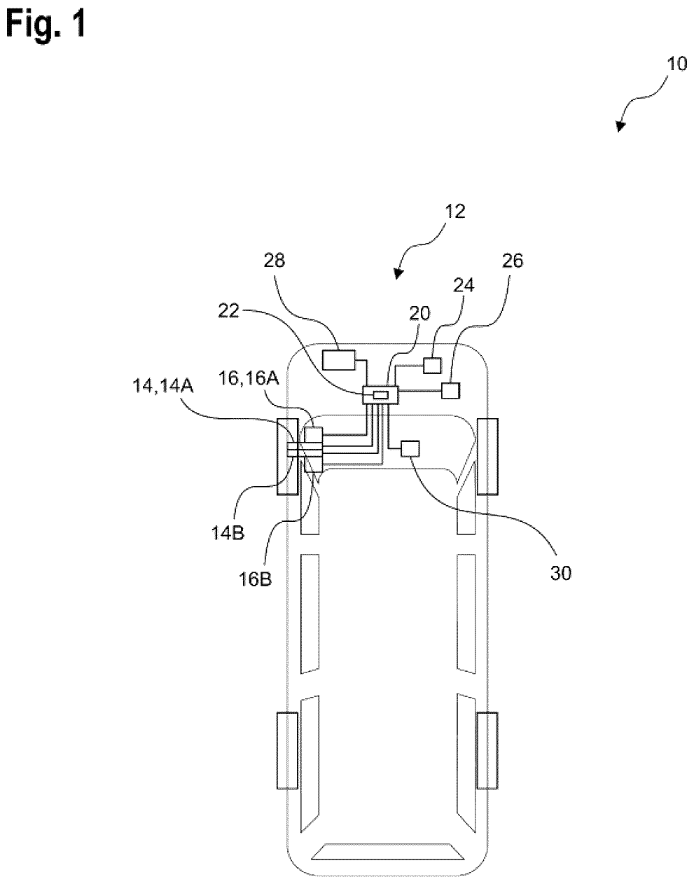

FIG. 1 shows a vehicle 10 with an electronic steering system 12 in accordance with examples disclosed herein.

The electronic steering system 12 includes a plurality of steering system components 14. A first steering system component 14A is designed in the form of a first road wheel actuator. A second steering system component 14B is also designed in the form of a road wheel actuator (e.g., with respect to the same road wheel, with respect to the same tie rod or steering rack). The second steering system component 14B is redundant relative to the first steering system component 14A. This means that the steering system components 14 have and implement the same functionality with respect to the electronic steering system 12. In other words, both the first steering system component 14A and the second steering system component 14B can be used to vary an angular position of steerable road wheels of the vehicle 10.

The electronic steering system 12 is configured such that the steerable road wheel of the vehicle 10 is initially steered exclusively by way of the first steering system component 14A. If the first steering system component 14A were to be faulty, the road wheel of the vehicle 10 can then be steered using the second steering system component 14B.

In other examples, the electronic steering system 12 can be configured such that both steering system components 14A and 14B each partially steer the road wheel of the vehicle 10 at the same time. If one of the two steering system components 14A or 14B fails, the wheel of the vehicle 10 can then continue to be steered using the second remaining (fault-free) steering system component 14A or 14B.

The electronic steering system 12 also includes sensors 16 which are assigned to the steering system components 14. A first sensor 16A is assigned to the first steering system component 14A. In addition, a second sensor 16B is assigned to the second steering system component 14B. The sensors 16 are configured to support the self-diagnosis of the electronic steering system 12 and to detect faults in the respective steering system components 14. A fault may be present not only in the event of total inoperability of the steering system component 14, but also if the steering system component 14 can still be operated in general, but its functionality does not correspond to the standard behavior. As a result of the fault, the operation of the steering system component 14 does not give rise to the expected effect. This faulty operating mode of the steering system component 14 is also considered to be a fault.

In addition, the electronic steering system 12 includes a control device 20, which includes a data processing device 22. The control device is coupled to the steering system components 14 and the sensors 16.

According to the illustrated example, the electronic steering system 12 also includes or is coupled to a communication device 24. In addition, the electronic steering system 12 includes or is coupled to a position receiver 26. Furthermore, the electronic steering system 12 is coupled to a higher-level driving control device 28 and an output device 30 of the vehicle 10. The control device 20 is coupled to the communication device 24, the position receiver 26, the higher-level driving control device 28, and the output device 30.

Via the communication device 24, the control device 20 can communicate with an external server and receive, for example, position data or cartographic data.

The position receiver 26 is configured to receive a position signal from a global navigation satellite system and to transmit it to the control device 20. This enables the control device 20 to determine a vehicle position of the vehicle 10.

From the higher-level driving control device 28, the control device 20 can receive information, for example, a battery remaining range.

Utilizing the output device 30, the control device 20 can output range information in the form of a notification to a driver of the vehicle 10. For example, the output device 30 can be a display.

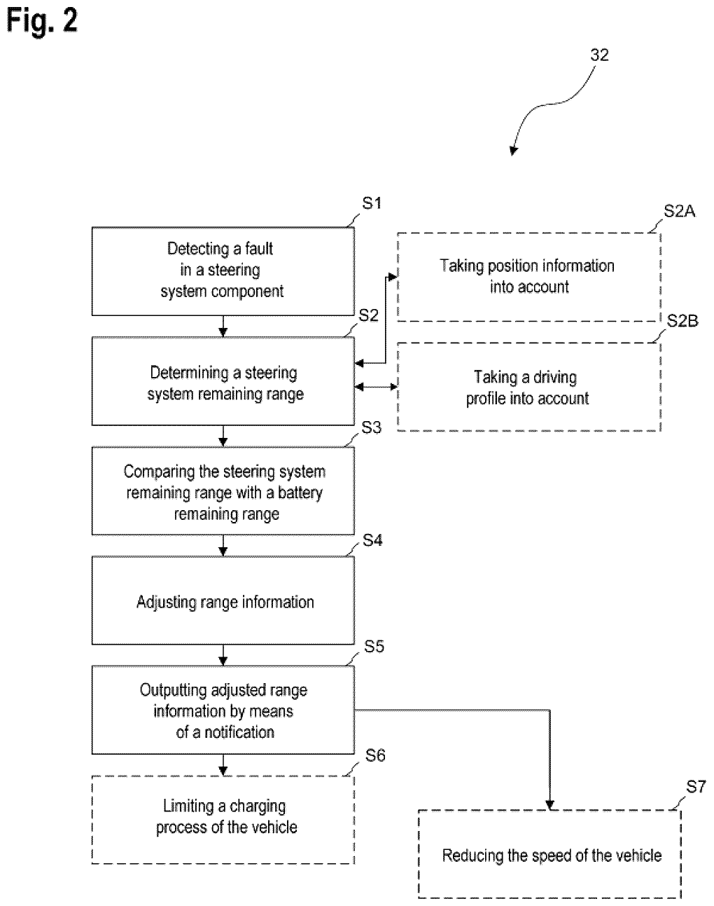

FIG. 2 shows an example method 32 for operating the vehicle 10 with the electronic steering system 12. In some examples, operations represented by dashed lines may be omitted.

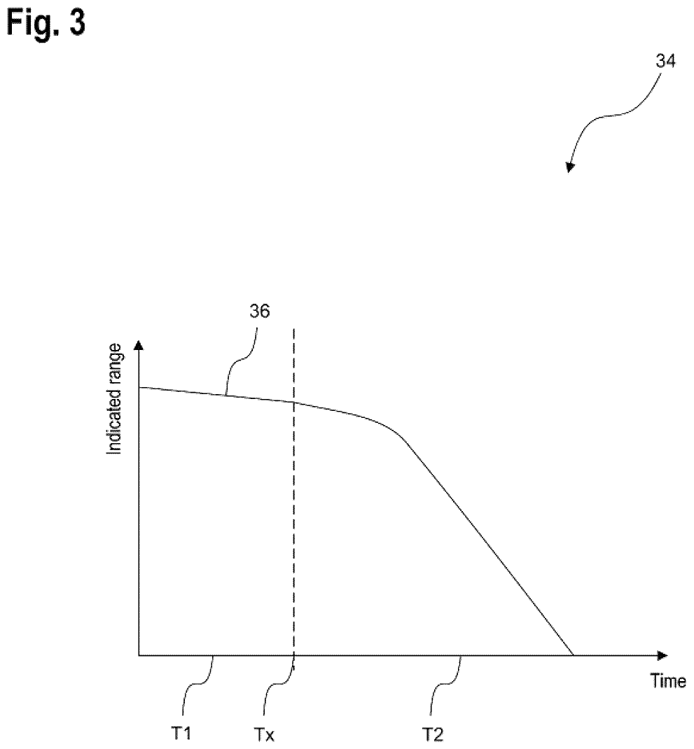

FIG. 3 shows a schematic representation 34 of an output item of range information 36. On the x-axis of illustration 34, time is plotted relative to a range displayed for the driver on the y-axis, which corresponds to the range information 36 output in each case.

During the time interval T1, the electronic steering system 12 operates as desired. In the illustrated example, the range information 36 output is generally decreasing. As the vehicle 10 moves forward, the range information 36 output is of course reduced according to the distance traveled. Nevertheless, the range information 36 output corresponds to a vehicle range which is justified, for example, by the battery state of charge or the fuel tank fill level. In this case, a remaining range is determined by the higher-level driving control device 28 based on a conventional driving profile of the vehicle 10, and output in the form of a notification to the driver as output range information 36.

At time Tx, the method 32 includes operation S1, in which a fault is detected in the first steering system component 14A (in general: one of the mutually redundant steering system components 14, for example three or more). For example, the fault in the first steering system component 14A can be detected via the sensor 16A, or the control device 20 can determine based on measurement data of the sensor 16A that the first steering system component 14A is no longer functioning properly.

As a result, in the following operation S2 the control device 20 of the electronic steering system 12 determines a steering system remaining range of the vehicle for which the vehicle 10 can continue to be operated with the second steering system component 14B. The steering system remaining range corresponds to a distance for which the vehicle 10 can still be operated, even though the first steering system component 14A is not operating as intended.

Operation S2 can be configured in a variety of ways. For example, according to the operation S2A the control device 20 can consider position information when determining the steering system remaining range. In the illustrated example, the position of the vehicle 10 can be determined, for example based on the position receiver 26. In other examples, cartographic data can be considered, which the control device has received from an external server, for example, by means of the communication device 24. The cartographic data may include information on the locations of car parks, garages and charging stations. Based on the cartographic data, the control device 20 can determine whether a suitable parking facility, a garage, the home location, or a charging station is located within a distance from the current position of the vehicle 10 which can still be reached by the vehicle 10. If the control device 20 determines that a suitable parking facility, a workshop, the home location, or a charging station is located at an accessible distance to the current vehicle position of the vehicle 10, the steering system remaining range can be limited by the distance to the determined suitable parking facility, workshop, home location or charging station.

The operation S2 can preferably also be extended by operation S2B, in which a driving profile is considered when determining the steering system remaining range. The driving profile can correspond to the conventional driving profile which is also considered by the higher-level driving control device 28 for determining a remaining range of the vehicle 10. In accordance with operation S2B, the conventional driving profile is multiplied by a factor that reflects the still permissible distance over which the vehicle 10 may still be operated. On the other hand, the driving profile may also correspond to an actual driving profile of the vehicle 10, in which, for example, the driving style of the driver or the driving situation of the vehicle 10 is considered. In other examples, consideration can also be given to whether the vehicle 10 is on a fast road, a motorway or in city traffic. Due to the different driving situations, for example, different average speeds can be determined, which can be multiplied by the permissible remaining operating time of the vehicle 10 to determine the steering system remaining range. The respective driving situation, considering the cartographic data, can also have an influence on the steering system remaining range. If the vehicle 10 is located, for example, on the motorway, the steering system remaining range can be determined at least in such a way that the nearest motorway exit can be reached, optionally with a suitable parking facility or similar.

The method 32 includes operation S3, following operation S2, in which the steering system remaining range is compared with a battery remaining range of the vehicle 10, for example, by the control device 20. The control device 20 can receive information about the battery remaining range, for example, from the higher-level driving control device 28. This allows the option of considering the remaining range that is smaller for the subsequent operations of the method 32.

Subsequently, the method 32 includes operation S4, in which range information is adjusted based on the steering system remaining range, for example, by the control device 20. This means that the range information 36 output during the time interval T1 (see FIG. 3) is adjusted by the control device 20 from now on.

During the time interval T2 (see FIG. 3), the range information 36 is output by means of a notification for the driver of the vehicle 10 in operation S5 of the method 32, for example via the output device 30. The remaining range of the vehicle 10 displayed to the driver now no longer corresponds to the original remaining range but is being continuously reduced compared to the original value. This does not correspond to the distance traveled by the vehicle 10 during the execution of the method 32 but is an intentional reduction of the displayed range of the vehicle 10 to cause the driver of the vehicle 10 to park the vehicle 10.

In this context, the range information 36 output in operation S4 can be adjusted in such a way that it does not undergo an abrupt change during the time interval T2, but a dynamic and continuous change. This can prevent the driver from being confused by a sudden change in the range information 36 displayed. Instead, the change of the displayed range information 36 can occur gradually, which will increase the compliance of the driver for the necessity to park the vehicle 10.

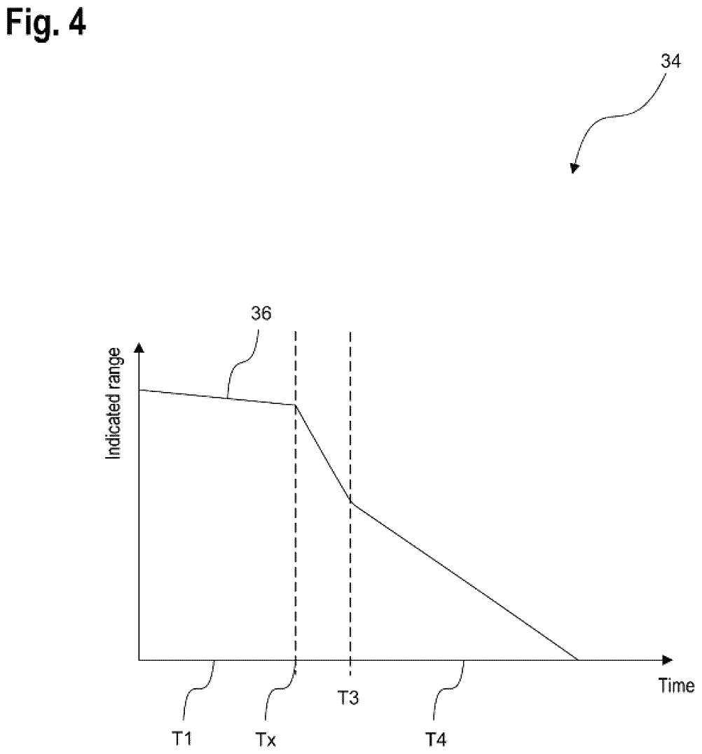

An alternative range reduction is shown in FIG. 4, which shows an illustration 34 of a range information 36 output in connection with the method 32 after a fault in the steering system 12. Again, at time Tx a fault is detected in the first steering system component 14A (in general: one of the mutually redundant steering system components 14, for example three or more). In the illustrated example, the range information 36 output after the detection of the fault is initially reduced by a large amount by time T3. Following time T3, a reduced change in the range information 36 is output during the time interval T4. As a result, the relatively rapidly decreasing range information 36 between Tx and T3 motivates the driver of the vehicle 10 to steer the vehicle 10 promptly to a suitable parking space.

In operation S5, additional information for the driver of the vehicle 10 can also be provided via the notification, for example position information regarding suitable parking facilities, garages or charging stations which can still be reached based on the adjusted range information.

The method 32 can also be extended by the operation S6, in which a charging process of the vehicle 10 is limited. In operation S3, it may be determined that the battery remaining range is less than the steering system remaining range. As a result, the user of the vehicle 10 may be forced to charge the vehicle 10 at a charging station. This charging process can be limited by the control device 20 by way of operation S6. In particular, the charging process can be limited in such a way that only a limited amount of electrical charge can be charged. The charging process can be limited in such a way that the sum of the battery remaining range still available before the charging process and the battery remaining range achieved after the charging process is equal to the steering system remaining range.

The method 32 can also be extended by operation S7, in which a speed of the vehicle 10 is reduced by the control device 20 after a distance corresponding to the output range information. This means an additional mechanism can be created so that the vehicle 10 is no longer operated after a fault in the first steering system component 14A.

Thus, a wide range of advantages can be substantially ensured using the method 32. For example, known display information that is familiar to the driver of the vehicle 10 (e.g., remaining range) can be used to induce the driver of the vehicle to stop the vehicle 10. The method 32 substantially increases the likelihood that the driver of the vehicle 10 will follow the instructions given for stopping the vehicle 10 at a specified location, for example, a dedicated parking facility. In addition, the method 32 allows an unexpected automatic speed reduction (e.g., stopping) of the vehicle 10 to be prevented. An additional error message, which is unfamiliar to the driver of the vehicle 10, can also be avoided. The adjusted range information 36 is also determined considering a variety of factors, such as cartographic data or driving profiles. In this way, the vehicle 10 can be brought to a stop at a suitable place.

Example instructions and/or operations of FIG. 2 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, a hard disk drive (HDD), a flash memory, a read-only memory (ROM), a compact disc (CD), a digital versatile disc (DVD), a cache, a random-access memory (RAM) of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random-access memory of any type, read-only memory of any type, solid-state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

Specific examples disclosed herein, in particular the control device, may use circuits (e.g. one or more circuits) to implement standards, protocols, methods or technologies disclosed herein, to couple two or more components in a functional manner, to generate information, to process information, to analyze information, to generate signals, to encode/decode signals, to convert signals, to transmit and/or receive signals, to control other devices, etc. Any type of circuit can be used.

In some examples, a circuit such as the control device comprises at least one or more data processing devices such as a processor (e.g. a microprocessor), a central processor unit (CPU), a digital signal processor (DSP), an application-specific integrated circuit (ASIC), a field programmable gate array (FPGA), a system on a chip (SoC) or similar, or any combination thereof, and may comprise discrete digital or analog circuitry or electronics or combinations thereof. In some examples, the circuit comprises hardware circuit implementations (e.g. implementations in analog circuits, implementations in digital circuits and the like, and combinations thereof).

In some examples, circuits comprise combinations of circuits and computer program products with software or firmware instructions, which are stored on one or more computer-readable memories and interact to cause a device to perform one or more of the protocols, methods or technologies described herein. In some examples, the circuit technology comprises circuits, such as microprocessors or parts of microprocessors, that require software, firmware and the like for their operation. In some examples, the circuits comprise one or more processors or parts thereof and the associated software, firmware, hardware and the like.

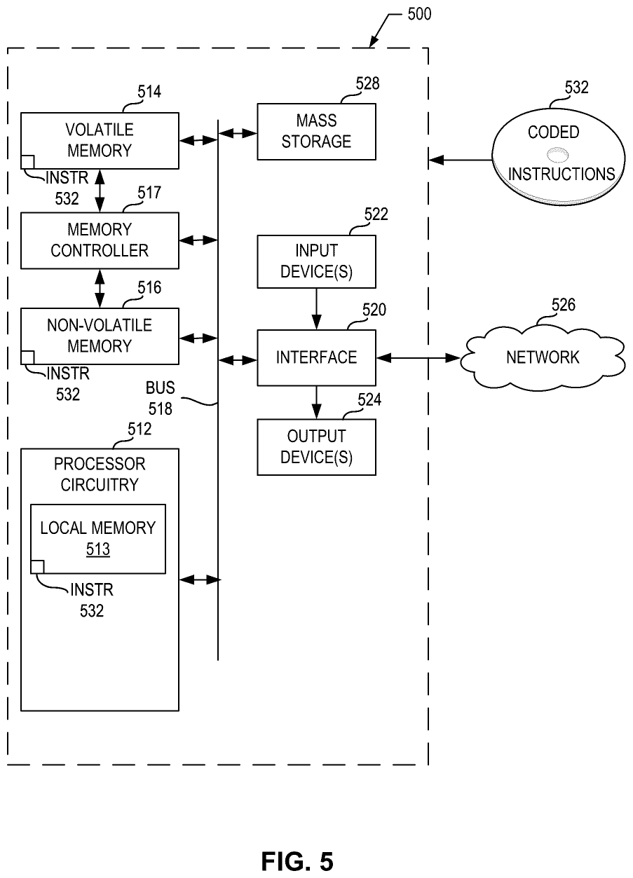

FIG. 5 is a block diagram of an example programmable circuitry platform 1000 structured to execute and/or instantiate the example machine-readable instructions and/or the example operations of FIG. 2 to implement the electronic steering system 12 and/or its various components disclosed herein. The programmable circuitry platform 500 can be, for example, a control device, an ECU, a self-learning machine (e.g., a neural network), or any other type of computing and/or electronic device.

The programmable circuitry platform 500 of the illustrated example includes programmable circuitry 512. The programmable circuitry 512 of the illustrated example is hardware. For example, the programmable circuitry 512 can be implemented by one or more integrated circuits, logic circuits, FPGAs, microprocessors, CPUs, GPUs, VPUs, DSPs, and/or microcontrollers from any desired family or manufacturer. The programmable circuitry 512 may be implemented by one or more semiconductor based (e.g., silicon based) devices.

The programmable circuitry 512 of the illustrated example includes a local memory 513 (e.g., a cache, registers, etc.). The programmable circuitry 512 of the illustrated example is in communication with main memory 514, 516, which includes a volatile memory 514 and a non-volatile memory 516, by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517. In some examples, the memory controller 517 may be implemented by one or more integrated circuits, logic circuits, microcontrollers from any desired family or manufacturer, or any other type of circuitry to manage the flow of data going to and from the main memory 514, 516.

The programmable circuitry platform 500 of the illustrated example also includes interface circuitry 520. The interface circuitry 520 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user (e.g., a human user, a machine user, etc.) to enter data and/or commands into the programmable circuitry 512. The input device(s) 522 can be implemented by, for example, an audio sensor, a microphone, a camera (still or video), a button, a touchscreen, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 500 of the illustrated example also includes one or more mass storage discs or devices 528 to store firmware, software, and/or data. Examples of such mass storage discs or devices 528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 532, which may be implemented by the machine-readable instructions of FIG. 3, may be stored in the mass storage device 528, in the volatile memory 514, in the non-volatile memory 516, and/or on at least one non-transitory computer readable storage medium such as a CD or DVD which may be removable.

This disclosure may refer to quantities and figures. Unless expressly stated, such quantities and numbers shall not be considered as limiting, but as examples of the possible quantities or numbers in connection with the disclosure. In this context, the term “plurality” may also be used in the disclosure to refer to a quantity or number. In this context, the term “plurality” shall mean any number greater than one, for example, two, three, four, five, etc. The terms “roughly”, “approximately”, “near”, etc. mean plus or minus 5% of the value specified.

Although the disclosure has been presented and described with respect to one or more examples, after reading and understanding this description and the accompanying drawings, a person skilled in the art will be able to make equivalent changes and modifications.

Example methods, apparatus, systems, and articles of manufacture to enable operating a vehicle with an electronic steering system and electronic steering systems are disclosed herein. Further examples and combinations thereof include the following:

Example 1 includes a method comprising detecting a fault in at least one of a first steering system component or a second steering system component (14A, 14B), determining a first range of a vehicle (10) based on the fault in the at least one of the first steering system component or the second steering system component, determining adjusted range information of the vehicle (10) based on a comparison of the first range with a battery range of the vehicle (10), and substituting the battery range of the vehicle (10) in an output device of the vehicle (10) with the adjusted range information.

Example 2 includes any preceding clause(s) of the method of example 1, wherein the adjusted range information corresponds to the battery range if the battery range is less than the first range, and the adjusted range information corresponds to the first range if the first range is less than the battery range.

Example 3 includes any preceding clause(s) of any one or more of the methods of examples 1-2, wherein a charging process of a battery of the vehicle (10) is limited so that a total battery range corresponds at most to the first range.

Example 4 includes any preceding clause(s) of any one or more of the methods of examples 1-3, wherein the determining of the first range is further based on position information, wherein the position information includes a location of the vehicle (10) and at least one of a charging station location, a parking space location, a garage location, or a home location.

Example 5 includes any preceding clause(s) of any one or more of the methods of examples 1-4, wherein the determining of the first range is based on at least one of an actual driving profile of a driver of the vehicle or an average driving profile.

Example 6 includes any preceding clause(s) of any one or more of the methods of examples 1-4, wherein a vehicle speed is reduced after traveling a distance corresponding to the adjusted range information.

Example 7 includes an electronic steering system (12) for a vehicle (10) including a first steering system component (14A), a second steering system component, and a control device including machine-readable instructions to cause the control device to detect a fault in either of the first and second steering system components (14A, 14B), determine a first range of the vehicle (10) for which the vehicle (10) can continue to be operated with a non-faulty one of the first and second steering system components (14A, 14B), determine adjusted range information based on a comparison of the first range and a battery range of the vehicle (10), and substitute the battery range in an output device of the vehicle (10) with the adjusted range information.

Example 8 includes any preceding clause(s) of any one or more of the electronic steering system (12) of example 7, wherein the first steering system component (14A) and the second steering system component (14B) are steering actuators.

Example 9 includes any preceding clause(s) of any one or more of Examples 7-8 the electronic steering system (12) of example 7, wherein the first steering system component (14A) and the second steering system component (14B) are road wheel actuators.

Example 10 includes any preceding clause(s) of any one or more of the electronic steering systems (12) of examples 7-9, wherein the adjusted range information corresponds to the battery range if the battery range is less than the first range, and that the adjusted range information corresponds to the first range if the first range is less than the battery range.

Example 11 includes any preceding clause(s) of any one or more of the electronic steering systems (12) of examples 7-10, wherein the control device causes a total battery range of the vehicle (10) to be limited to the first range.

Example 12 includes any preceding clause(s) of any one or more of the electronic steering systems (12) of examples 7-11, wherein the control device is to determine the first range based on position information, wherein the position information includes a location of the vehicle (10) and at least one of a charging station location, a parking space location, a garage location, or a home location.

Example 13 includes any preceding clause(s) of any one or more of the electronic steering systems (12) of examples 7-12, wherein the control device is to determine the first range based on at least one of an actual driving profile of a driver of the vehicle or an average driving profile.

Example 14 includes any preceding clause(s) of any one or more of the electronic steering systems (12) of examples 7-8, wherein the control device is to cause reduction of a vehicle speed after traveling a distance corresponding to the adjusted range information.

Example 15 includes a steering system for a vehicle including a first sensor, a second sensor, and a control device with machine-readable instructions to cause the control device to detect a fault in either of the first sensor or the second sensor, determine a first range of the vehicle (10) for which the vehicle (10) can continue to be operated with a non-faulty one of the first sensor or the second sensor, set an adjusted range information equal to the first range based on the first range being less than a battery range of the vehicle, set an adjusted range information equal to the battery range based on the first range being greater than the battery range, and substitute the battery range of the vehicle (10) in a display of the vehicle (10) with the adjusted range information.

Example 16 includes any preceding clause(s) of the steering system of example 15, wherein the control device is to substitute the battery range of the vehicle with the adjusted range information by decreasing a displayed value in multiple increments over a first time interval to equal the adjusted range information.

Example 17 includes any preceding clause(s) of any one or more of the steering systems of examples 15-16, wherein the control device causes a charging process of a battery of the vehicle (10) to be limited so that a total battery range corresponds at most to the first range.

Example 18 includes any preceding clause(s) of any one or more of the steering systems of examples 15-17, wherein the control device determines the first range based on position information, wherein the position information includes a location of the vehicle (10) and at least one of a charging station location, a parking space location, a garage location, or a home location.

Example 19 includes any preceding clause(s) of any one or more of the steering systems of examples 15-18, wherein the control device determines the first range based on at least on one of an actual driving profile of a driver of the vehicle or an average driving profile.

Example 20 includes any preceding clause(s) of any one or more of the steering systems of examples 15-19, wherein the control device causes reduction of a vehicle speed after traveling a distance predefined by the adjusted range information.

What is claimed is:

1. A method comprising:
detecting a fault in at least one of a first steering system component or a second steering system component;
determining a first range of a vehicle based on the fault in the at least one of the first steering system component or the second steering system component;
determining adjusted range information of the vehicle based on a comparison of the first range with a battery range of the vehicle; and
substituting the battery range of the vehicle in an output device of the vehicle with the adjusted range information.

2. The method of claim 1, wherein the adjusted range information corresponds to the battery range if the battery range is less than the first range, and the adjusted range information corresponds to the first range if the first range is less than the battery range.

3. The method of claim 1, wherein a charging process of a battery of the vehicle is limited so that a total battery range corresponds at most to the first range.

4. The method of claim 1, wherein the determining of the first range is further based on position information, wherein the position information includes a location of the vehicle and at least one of a charging station location, a parking space location, a garage location, or a home location.

5. The method of claim 1, wherein the determining of the first range is based on at least one of an actual driving profile of a driver of the vehicle or an average driving profile.

6. The method of claim 1, wherein a vehicle speed is reduced after traveling a distance corresponding to the adjusted range information.

7. An electronic steering system for a vehicle including:
a first steering system component;
a second steering system component; and
a control device including machine-readable instructions to cause the control device to:
detect a fault in either of the first and second steering system components;
determine a first range of the vehicle for which the vehicle can continue to be operated with a non-faulty one of the first and second steering system components;
determine adjusted range information based on a comparison of the first range and a battery range of the vehicle; and
substitute the battery range in an output device of the vehicle with the adjusted range information.

8. The electronic steering system of claim 7, wherein the first steering system component and the second steering system component are steering actuators.

9. The electronic steering system of claim 7, wherein the first steering system component and the second steering system component are road wheel actuators.

10. The electronic steering system of claim 7, wherein the adjusted range information corresponds to the battery range if the battery range is less than the first range, and that the adjusted range information corresponds to the first range if the first range is less than the battery range.

11. The electronic steering system of claim 7, wherein the control device causes a total battery range of the vehicle to be limited to the first range.

12. The electronic steering system of claim 7, wherein the control device is to determine the first range based on position information, wherein the position information includes a location of the vehicle and at least one of a charging station location, a parking space location, a garage location, or a home location.

13. The electronic steering system of claim 7, wherein the control device is to determine the first range based on at least one of an actual driving profile of a driver of the vehicle or an average driving profile.

14. The electronic steering system of claim 7, wherein the control device is to cause reduction of a vehicle speed after traveling a distance corresponding to the adjusted range information.

15. A steering system for a vehicle including:
a first sensor;
a second sensor; and
a control device with machine-readable instructions to cause the control device to:
detect a fault in either of the first sensor or the second sensor;
determine a first range of the vehicle for which the vehicle can continue to be operated with a non-faulty one of the first sensor or the second sensor;
set an adjusted range information equal to the first range based on the first range being less than a battery range of the vehicle;
set the adjusted range information equal to the battery range based on the first range being greater than the battery range; and
substitute the battery range of the vehicle in a display of the vehicle with the adjusted range information.

16. The steering system of claim 15, wherein the control device is to substitute the battery range of the vehicle with the adjusted range information by decreasing a displayed value in multiple increments over a first time interval to equal the adjusted range information.

17. The steering system of claim 15, wherein the control device causes a charging process of a battery of the vehicle to be limited so that a total battery range corresponds at most to the first range.

18. The steering system of claim 15, wherein the control device determines the first range based on position information, wherein the position information includes a location of the vehicle and at least one of a charging station location, a parking space location, a garage location, or a home location.

19. The steering system of claim 15, wherein the control device determines the first range based on at least on one of an actual driving profile of a driver of the vehicle or an average driving profile.

20. The steering system of claim 15, wherein the control device causes reduction of a vehicle speed after traveling a distance predefined by the adjusted range information.
